(19) United States
(12) Patent Application Publication
(10) Pub. No.: US 2006/0041373 A1
(43) Pub. Date: Feb. 23, 2006

(54) System for safe and effective communication between a vehicle and a telecommunication center

(76) Inventor: Larry D. Rowe, Plymouth, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/208,968

(22) Filed: Aug. 22, 2005

Related U.S. Application Data
(60) Provisional application No. 60/603,847, filed on Aug. 23, 2004.

(51) Int. Cl. G01C 21/36

(52) U.S. Cl. 701/200; 701/211

(57) ABSTRACT

A multi-task communications system which is used to transmit, receive, and store information from various sources. This communications system allows vehicles to enhance road safety while communicating using a unique user input and display mechanism. The basic framework of the system comprises a telecommunications center which collects information from various partner organizations including banks or other financial institutions, restaurants, news and weather organizations, emergency organizations, and others. The heart of the system is a unit mounted in the vehicle. This unit includes a communications link, a GPS receiver, and a user interface which includes a speaker phone, display, and a series of LEDs.

### CROSS-REFERENCE TO CO-PENDING PROVISIONAL APPLICATION

This application claims the benefit of Provisional Application No. 60/603,847, filed Aug. 23, 2004, the entire content of which is hereby incorporated by reference in this application.

### BACKGROUND OF THE INVENTION

I. Field of the Invention

The present invention relates to multi-task communications systems for vehicles that are safer to use than existing cell phones, pagers, global positioning systems and navigation systems.

II. Related Art

In recent years, luxury automobiles have come equipped with integrated navigation, communication, vehicle performance reporting, and entertainment systems. One example is the navigation system with “iDrive” offered by BMW. Automobile manufacturers advertise these systems as “allowing the driver to effortlessly operate the navigation system and climate, communication and entertainment functions”. Such systems typically include a dash mounted display and a variety of knobs or switch arrays used to provide inputs to the system and access the system features. Such systems have certain disadvantages. First, the user interfaces are not particularly intuitive. Thus, people unfamiliar with their operation find them difficult to use. Second, they can distract the driver to the extent they cause accidents. Some are even labeled with a warning that tells drivers not to use the system while the vehicle is moving.

To overcome some of these problems, some vehicle manufacturers have developed devices with fewer functions and simplified user interfaces which surround the rear view mirrors of vehicles and include various communications and electronic devices.

For example, the Hutzel et al. published application 2003/0007261 teaches the concept of enclosing electronic components, including a display screen, such as a touch screen, that displays information for an occupant of the vehicle in a rear view mirror. This patent further suggests that the rear view mirror may have a compartment for holding a phone or pager, but it appears that the phone or pager would be removed from the compartment and, thus, the compartment is only for convenience storage.

The Burchette patent publication 2003/0006888 disclosures a mirror mounted cell phone, voice recorder, compass, police radar detector along with indicators to provide visual and audio alerts.

The Turnbull patent publication 2002/0193946 teaches the idea of incorporating a Loran positioning system within the rear view mirror of a vehicle.

With reference to the Odinak patent publication 2002/0173889, the concept of incorporation communications electronics in a rear view mirror of a vehicle is taught. This would typically include a user interface with an input device, a microphone, a display and speaker.

U.S. Pat. No. 6,158,655 describes a vehicle mounted remote transaction interface system for communication with a remote transaction unit for transaction, such as bank transactions with a bank teller unit or a drive-through point-of-sale transaction with a drive-through point-of-sale system for the purchase of food, beverages or other goods. A transmitter is mounted to either the vehicle cabin or the vehicular rear view mirror assembly. The input device is in communication with the transmitter and provides input to the transmitter which modulates the signals from the input device and transmits the modulated signal for communication with the remote transaction unit.

Many vehicles made by General Motors are equipped with the “OnStar” system having a mirror mounted user interface. Specifically, three switches are mounted on the mirror—a power switch, a call switch and an emergency switch. Vehicle owners can subscribe to a variety of levels of service. All services are provided via a wireless telephone link between the vehicle and a service center.

None of the items discussed thus far has the unique capabilities and design that is described as the subject of the present invention. Generally, though some related teachings exist, there is nothing in the prior art which would teach the present invention as a whole.

### SUMMARY OF THE INVENTION

The present invention is a multi-task communications system for vehicles designed to enhance road safety while communicating by providing a unique user interface mechanism. The basic framework of the system comprises a telecommunications center which collects information from various partner organizations that wish to communicate with the drivers of vehicles. These partners include banks or other financial institutions, restaurants who wish to take reservations or take-out orders, news and weather organizations, emergency organizations, and others. The heart of the system is a unit mounted in the vehicle. This unit includes a system controller, communications link, a GPS receiver, and a user interface which includes a speaker phone, display, multifunctional switches and a series of LEDs. The user interface is intuitive, easy to operate, designed to avoid subjecting the driver to unsafe distractions the driver and is typically mirror mounted.

More specifically, the present invention provides all of the advantages of existing cellular telephone, GPS, navigation and subscription systems, but combines them with a safe-to-use, highly intuitive user interface. Additional functionality is also provided by the present invention. This user interface is ideally mounted to the rear view mirror of the vehicle. The system of the present invention can be provided as a factory installed option or as an after-market product.

### OBJECTS OF THE INVENTION

An object of the invention is to provide a communications system which enhances road safety while communicating.

Another object of this invention is to provide a simple, easy-to-use user interface that can safely be used without any undue distraction of a driver.

Still another object of the invention is to provide a communications system which collects information from various organizations wishing to communicate with the driver of the vehicle.

A further object of the invention is to provide a communications system giving information related to one's bank account or investments.

Another object of the invention is to provide a system which allows communication with restaurants, news organizations or weather organizations, or emergency organizations.

Still another object of the invention is to provide a communications system which includes a GPS receiver for providing position information.

A further object of the invention is to provide a navigation system able to communicate information related to the user's travel route without the need to look at a map while driving.

Still another object of the invention is to provide a system which prevents the driver from using the system in an unsafe fashion while the vehicle is moving.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram of the vehicle communications system of the present invention.

FIG. 2 is a schematic of the onboard vehicle communication system of the present invention.

FIG. 3 is a side view of the rear view mirror-mounted user interface.

FIG. 4 is a schematic diagram of the rearview mirror-mounted user interface with the mirror in the “program” position.

FIG. 5 is a schematic diagram like FIG. 4 but with the mirror in the “drive” position.

### DETAILED DESCRIPTION OF THE PRESENT INVENTION

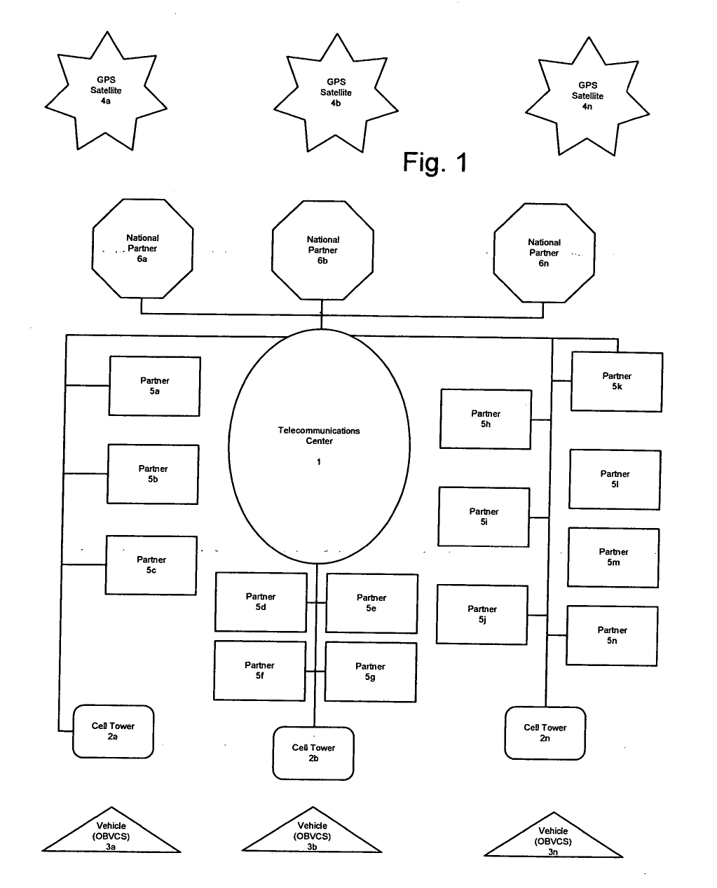

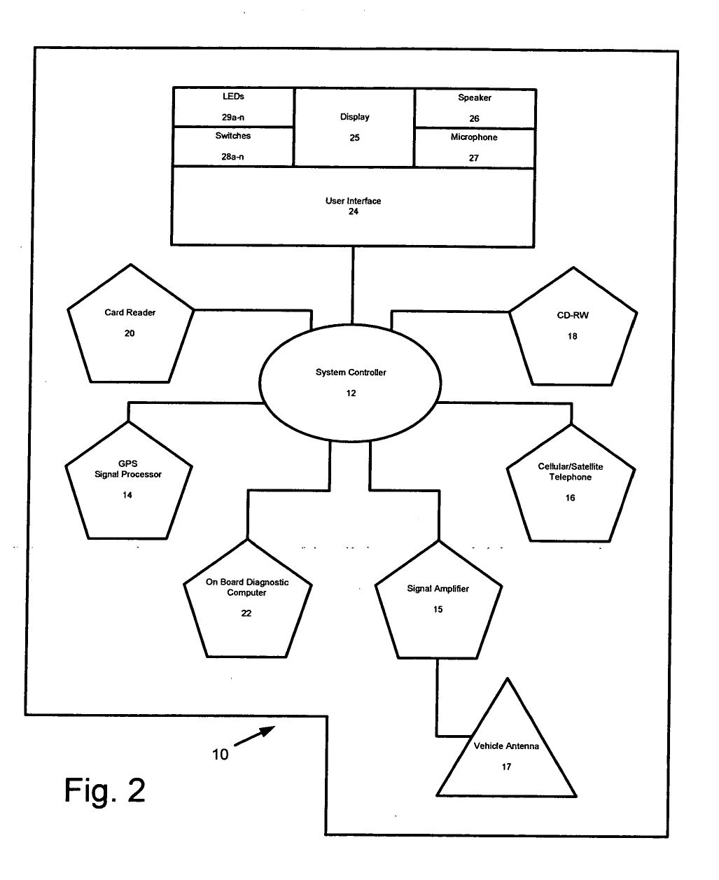

As shown in FIGS. 1 and 2, the integrated vehicle communication system of the present invention comprises a variety of subsystems located within the vehicle as well as a number of subsystems used to track and communicate with the vehicle. More specifically, FIG. 1 shows the network of communication devices used to communicate with the vehicle while FIG. 2 shows the devices installed in the vehicle used to communicate with the network shown in FIG. 1.

As shown in FIG. 1, the network includes a telecommunications center 1 and a plurality of cell towers 2a-n through which the telecommunications center 1 communicates with the onboard vehicle communications systems mounted in vehicles 3a-n as the vehicles travel throughout a geographic area. Those skilled in the art will recognize that the present invention can alternatively be implemented as a satellite-based communication system as opposed to a cellular-based system, where the cell towers 2a-n could be replaced by one or more satellites. Whether the system is implemented using satellites or cell towers, the number needed will depend upon system traffic and the geographic area to be covered.

The system shown in FIG. 1 uses GPS technology to identify the location of the vehicles 3a-n. Thus, GPS satellites 4a-n are shown. The onboard vehicle communication system in each vehicle 3a-n receives signals from the GPS satellites and uses these signals to determine the vehicle's position. Alternatively, the onboard vehicle communication system can use the signals received from cell towers in the area to determine the location of the vehicle. Both of these techniques are well known in the art.

The system shown in FIG. 1 contemplates that a vehicle operator may from time to time wish to communicate with various partners. Some of these partners are local partners and typically only communicate with the vehicle when the vehicle is in the proximity of the partner. Local partners 5a-n would typically be gas stations, restaurants, retail stores and the like in or near the area where the vehicle is located at the time. These partners can communicate with vehicles 3a-n when they are within the geographic area served by the partner either directly via cellular or satellite communication or through the telecommunications center 1. For this to happen effectively, the onboard vehicle communication systems mounted in vehicles 3a-n will typically transmit the location information to the telecommunications center 1. The telecommunications center 1 can then either pass this information to the partner which can contact the vehicles directly or, preferably, transmit messages about local partners 5a-n in the vicinity of the vehicle to the vehicle upon request.

The system of the present invention also contemplates the participation of national partners 6a-n. These national partners can be financial institutions such as a bank or brokerage house, news organizations, weather service providers, or any other institution with which the driver may wish to communicate. The messages received from national partners 6a-n may be national in scope or may be vehicle-location specific. For example, a national partner could transmit a location specific weather or traffic advisory based upon the location of the vehicle.

As indicated above, each vehicle 3a-n is equipped with an onboard vehicle communications system. As shown in FIG. 2, the onboard vehicle communication system 10 includes a system controller 12. Coupled to the system controller 12 is a GPS signal processor 14 which processes the signal received from the GPS satellites 4a-n to calculate the vehicle's position as it moves about the geographic area. The results of this calculation are reported by the GPS signal processor 14 to system controller 12 for further processing or transmission.

Also coupled to the system controller is a cellular or satellite telephone 16. The telephone 16 can be a permanently installed telephone or a portable telephone that can be removed from the vehicle when the driver exits. When a portable telephone is used, the phone is preferably placed in a cradle which connects the phone to the system controller. The connection between the telephone 16 and the system controller 12 can be a hard wire connection or a wireless connection using, for example, “Bluetooth” technology licensed by Bluetooth SIG. In any event, the telephone 16 is used to provide a communication link as the vehicle moves about the geographic area where network coverage is provided. Such links can be between the vehicle and the telecommunications center 1, between the vehicle and any of the partners 5a-n and 6a-n, or between the vehicle and other telephones or communications systems.

In addition to the voice and data link provided by the telephone 16 between the system controller 12 and, for example, the telecom center 1, data can also be supplied to the system controller in a number of other ways. Several are shown in FIG. 2.

One is through the use of a CD-Rom drive 18 with read and write capabilities. The CD-Rom drive 18 can be used to supply mapping or other data to the system controller 12. Such other data could include directories of various associated telephone numbers, and/or associated locations. It can also be used to retrieve data from the controller 12. It is particularly useful when large quantities of data are involved Those skilled in the art will recognize that the CD-Rom drive 18 shown could be replaced with various alternatives without deviating from the invention. Such alternatives include a DVD drive, a flash drive or even a port, such as a USB or firewire port, through which some other storage device (or even a laptop computer) can temporarily be connected to deliver data to the system controller 12. The system controller 12, itself, includes the processing power, software, firmware, and memory, and storage necessary to control and operate the onboard vehicle communication system 10.

Data can also be supplied to the system control 12 using a magnetic card reader 20. The magnetic card reader can be used to read the credit card belonging to someone choosing to use the present invention when it is installed, for example, in a rental vehicle. The credit card reader can also be used to make credit card purchases from the partners 5a-n and 6a-n.

The system controller 12 can also be coupled to the vehicle's separate onboard diagnostic computer 22. This offers several advantages. First, the system controller 12 can send vehicle diagnostic data to the display of the user interface 24 for the driver to see. Second, the system controller 12 can report mechanical problems detected by the onboard computer 22 to either the telecommunications center 1 or one of the partners 5a-n, 6a-n using the telephone 16. Third, this feature can be used to automatically report an airbag deployment, which typically only occurs if there is a serious accident, to the telecommunications center 1 or to local emergency authorities and/or police. If the vehicle is equipped with a keyless entry or smart key system that signals the identity of the driver to the vehicle to set seat position. Fourth, the system controller 12 of the onboard vehicle communication system 1 can receive instructions via the telephone 16 and, based upon those instructions, send signals to the onboard computer. For example, if the vehicle is reported stolen, this feature can be used to disable the engine. It can also be used to remotely open the vehicle's door locks if the key are locked in the vehicle.

Further, different drivers of a vehicle equipped with the system of the present invention may have different preferences related to its use and operation. Once the preferences are established for a driver and stored in the system controller 12, there are several ways to signal which driver is using the car. These signals can be delivered to the system controller 12 from the onboard vehicle diagnostic computer 22 of a vehicle equipped with a keyless entry or smart key system that uses separate transmitters for each driver. These transmitters typically send a unique signal to the vehicle for each driver. These signals can also be sent to the system controller 12 from the specific user's portable telephone 16. These signals can be sent to the system controller 12 by actuating a switch on the user interface 24. The system controller 12 can even ask the driver to deliver a voice command identifying the driver.

Significant technological advances provided by the present invention relate to the user interface 24 which is also connected to the system controller 12 as shown in FIG. 2. The user interface includes a display 25, a speaker 26, a microphone 27 and a series of multifunctional switches 28 and associated LEDs 29. The user interface 24 is ideally suited to enable safe, non-distracting communication not only between the system controller and the driver, but also between the driver and the telecommunications center 1, partners 5a-n, 6a-n, other vehicles 3a-n, or other telephones located anywhere in the world.

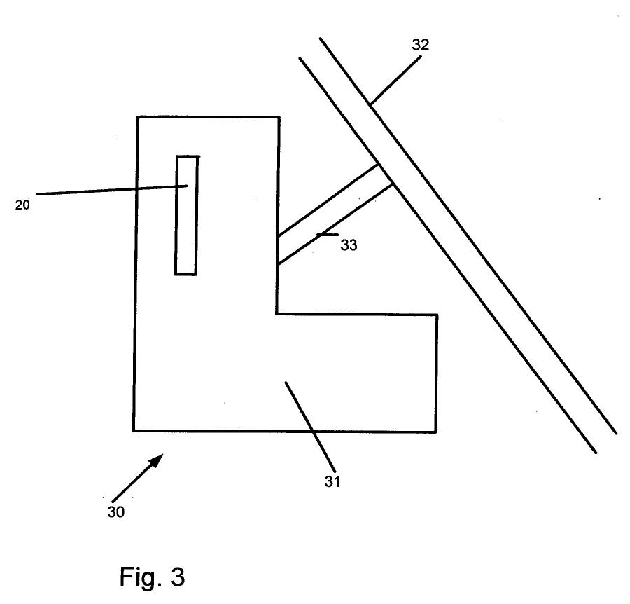

FIGS. 3-5 show a preferred user interface 24 of the preferred invention. The user interface 24 is preferably mounted to a specially designed rearview mirror assembly 30 that can be used (or modified for use) in any vehicle. As shown in FIG. 3, the mirror assembly 30 includes a housing 31 secured to a surface (typically either the roof or windshield) the vehicle 32 by a support 33. Also shown in FIG. 3 is the slot for magnetic card reader 20.

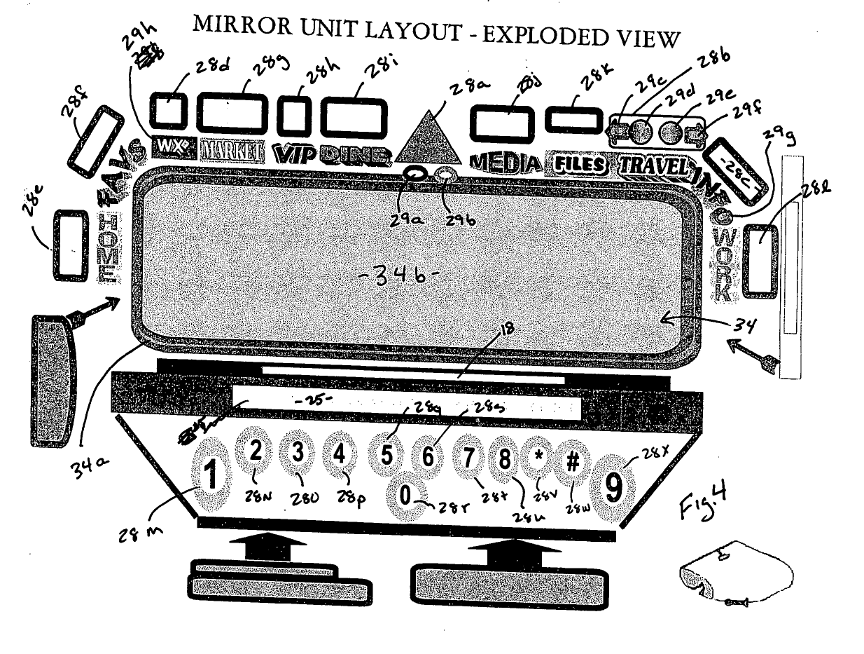

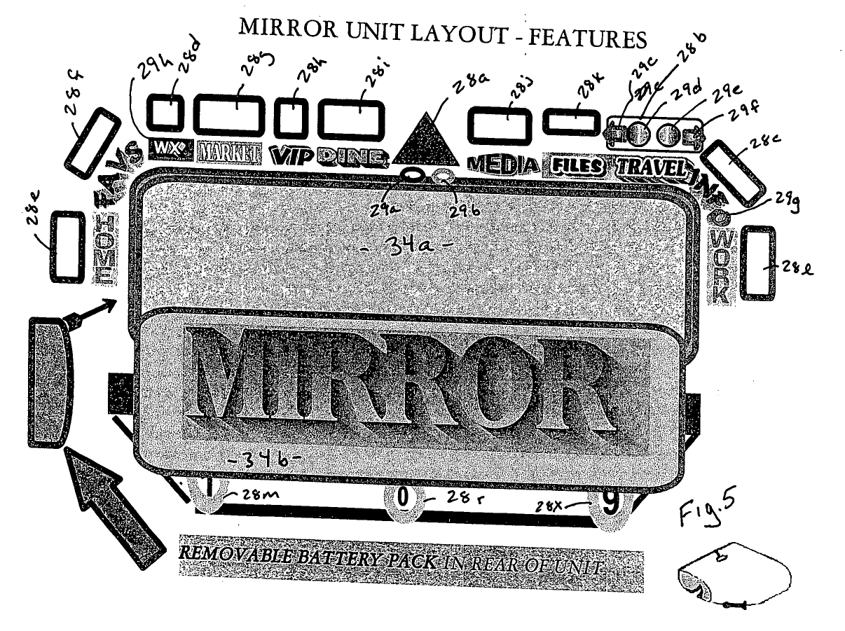

A mirror 34 is mounted to the mirror assembly 30. The mirror 34 has a stationary section 34a and a movable section 34b. In FIG. 4, the movable section 34b is in the “park” or “program” position. In FIG. 5, the movable section 34b is in the “drive” position.

The user interface 24 includes an array switches 28 and LEDs 29 generally surrounding the stationary section 34a of the mirror 34. At the center of the array is a triangular shaped switch 28a. This is the main communications switch. A telephone link to the telecommunications center 1 is established by pressing this switch once. Other functions of this switch are discussed below.

Closely associated with switch 28a are LEDs 29a and 29b. LED 29a will flash white when an emergency vehicle in the area is controlling traffic lights in the driving area. Emergency vehicles control the traffic lights by emitting a signal that can be picked up by the antenna 17 and amplified by the amplifier 15. More specifically, when the system controller 12 receives a signal from amplifier 15 (via antenna 17) that an emergency vehicle is emitting a traffic light control signal, the system controller causes LED 29a to flash. Thus, it serves, in addition to the flashing lights or siren of the emergency vehicle, as another alert to the driver of the presence of such emergency vehicles in the area.

LEDs 29b-f are associated with the system's travel planning function. Any number of travel plans or destinations can be stored in the system controller 12. LED 29b illuminates whenever a driver has selected one of said travel plans or destinations. LEDs 29c-f provide directions to the driver based upon the preloaded trip plan or destination. Specifically, using mapping information, the known location of the selected destination, and the signals generated by the GPS signal processor 14, the system controller 12 illuminates LEDs 29c-f to signal expected stops and turns associated with the route to the destination. Likewise, the speaker 26 is used by the system controller 12 to provide audible instructions to the driver. This is believed to provide increased safety because, unlike navigation systems that display a map, the driver need not read a map or otherwise be distracted by a map when driving.

The system also provides several alert LEDs. “Information” alert LED 29g is illuminated when local authorities have issued an alert or when there is an available traffic update. A multi-colored LED can be used to indicate the nature of the alert. For example, an amber color can be used to indicate when local authorities have issued an “amber” alert indicating an abduction has taken place. A weather LED 29h is used to signal weather alerts affecting the area where the vehicle is located. To retrieve information related to alerts signaled by LEDs 29g and 29h, the driver can depress the switch associated with the LED (switches 28c and 28d, respectively) and then the main switches 28a. When a telephone connection is established with the telecommunications center 1 (or partners 5a-n or 6a-n) information related to the alert is transmitted to the vehicle, and the system controller 12 causes the information related to the alert to be played over the speaker 26.

The user interface also has a plurality of user programmable, multifunction switches (i.e., switches 28e-l) and associated LEDs. To save space, the LEDs can be incorporated into the switches. One function performed by these switches is a unique speed dial function. A plurality of telephone numbers can be stored in the memory of system controller 12. One or more of each of these telephone numbers can be associated with each of switches 28e-1 as well as switch 28b. For example, the telephone numbers of family members can be associated with the “home” switch 28e. Friends and other frequently called numbers can be associated with the “fav” switch 28f. The phone numbers of local businesses or brokers could be associated with the “market” switch 28g. The phone numbers of doctors and dentists could be associated with the VIP switch 28h. The numbers of restaurants could be associated with the “dine” switch 28i. The “files” switch 28k could be used for retrieval of voicemail. The “travel” switch 28b could be associated with the telephone numbers of airlines, hotels, travel agents, or auto repair centers. The “work” switch 281 could be associated with the phone numbers of business contacts. The media switch 28j could be associated with news outlets, talk radio stations or the like.

Ideally, the switches 28a-1 are all of a type that can be toggled in different ways to send different signals to the controller 12. Thus, when the speed dial function is used, one portion of the switch is depressed to cause the controller 12 to start listing the contacts associated with the switch over the speaker 26. Other portions of the switch can be used to step forward or back through the list. As the desired contact is listed, the call is simply placed by actuating the main switch 28a.

The multifunction switches 28a-n can also be used to obtain desired information from the telecommunications center 1 or partners 5a-n and 6a-n. For example, if one is interested in contacting a local restaurant, one can depress the main switch 28a twice to contact the telecommunications center 1 and then depress the dine switch 28i. The telecommunications center then can transmit a list of restaurant options to the vehicle which are played over the speaker. The dine switch 28i can be actuated to move back and forth through the menu. Also the dine switch 28i (or alternatively the main switch 28a) can be used to connect to the restaurant (partners 5a-n) of interest. The other multifunction switches can be used to retrieve a topical list from the telecommunications center 1 and make a similar connection, but to a different type of establishment. The telecommunications center 1 receives vehicle location information from the vehicle when the driver makes the connection so the list transmitted and played are edited at the telecommunications center 1 based upon the location of the vehicle. The lists stored in the system controller 12 in combination with the numbers stored in the telecommunications center 1 make it possible to quickly and easily make virtually any telephone connection using just two switches. In cases where this is not possible, an operator at the telecommunications center 1 can make the connection.

Telephone numbers and other data to be stored in the system controller 12 can be input using various methods, but preferably only when the vehicle is parked. When one desires to do so, the movable section 34b of mirror 34 is moved from the position shown in FIG. 4 to the position shown in FIG. 5. This exposes a key pad including switches 28m-x, display 25, and the access door to the CD-Rom drive 18. While not shown, moving the door could also expose a port, such as a USB port, which could be used to program the system controller 12. These devices, along with the microphone, can be used to input telephone directory information and associate it with the various multifunction switches of the user interface. They can also be used to provide mapping information and destination information for use by the system in delivering travel directions to the driver.

Just as the various multifunction switches can be associated with telephone numbers to provide menuing for a speed dial function, they can be similarly used to identify which preprogrammed destination to which the driver wishes to travel using a similar menuing scheme. For example, each of the multifunction switches can be toggled in five different ways. Pressing the right side of the switch activates the speed dial menu associate with the switch. Pressing the left side of the switch activates the destination menu associated with the switch. Pressing the top advances the system to the next item in the selected menu. Pressing the bottom replays the previous menu item. Pressing the middle (or, alternatively, the main switch) selects the menu option. In the case of the speed dial function, a telephone connection is initiated. In the case of the destination function, the system controller calculates a route from the vehicle's present location to the destination and begins using the LEDs 29c-f and speaker 26 to direct the driver to the destination.

A significant safety feature is the driving position of the mirror portion 34b. When in this position, access to the CD-Rom 18, the display 25 and all but three of switches 28m-x are covered. Only switches 28m, 28r and 28x remain exposed. This is so the driver can call, and only can call, either the operator, local 911 emergency services, or personnel at the call center equipped to provide directions to the nearest emergency care facility. Dialing “0” connects the driver to a local operator. Dialing 911 connects the driver to local 911 emergency services. Dialing “9” or any other combination of numbers connects the driver to a person at the telecommunications center 1 who can provide assistance or directions in an emergency.

Safety is also enhanced by the speaker 26 and microphone 27 of the user interface 24. These devices enable hands-free telephone communication with the telecommunications center 1, the local partners 5 a-n, national partners 6a-n, or anyone else. Voice commands can also be delivered to the system controller 12 using the microphone 27 eliminating the need to actuate some or all of the multifunctional switches 28a-n.

For example, when LED 29g or 29h is illuminated indicating that an alert is available, the driver can speak the word “command” to activate the system and then “play weather” or “play info”. In response, the system controller 12 will automatically play the associated alert over the speaker. Of course, if the alert is not already stored in the system controller 12, the system controller 12 will automatically establish a telephone connection with either the telecommunications center 1 or the partner 5a-n, 6a-n issuing the alert, retrieve the alert, and play the alert over the speaker 26. Similar voice commands can be used to retrieve other messages when other LEDs 28a-n associated with other switches are illuminated.

Likewise, when the driver wishes to use the speed dial system, the driver can speak the word “command” to activate the system and then “speed dial” followed by the name of the switches 28a-n (e.g. “dine”) associated with the speed dial list the driver wishes to hear. The names in the associated list are then played over the speaker. When the driver hears the correct name, the driver can then say “dial now” and the system will establish a connection to the desired party. Of course, if the driver knows the name of the party, the driver can simply peak the commands “command” and “speed dial” followed by the desired party's name. Alternatively, the system could be set up so the driver actuates one of the switches (e.g. 28a) to activate the system and says “speed dial” followed by the party's name.

A similar spoken set of commands can be used to establish connections with local and national partners. The driver says “command” to activate the system. The driver then says the name of the desired switch followed by either the command “local partners”, “national partners” or “all partners”. The system controller then establishes a connection with the telecommunications center 1 and retrieves the proper menu and plays it over the speaker. For example, if the driver says “dine” and “local partners” a list of local restaurants in the area where the vehicle is located is played. When the desired partner's name comes over the speaker, the driver can say “dial now” causing the system controller to establish a connection with that partner.

Those skilled in the art will recognize that a key advantage is that a driver need not (and in fact cannot) dial a telephone number of seven digits or more. Instead, the system can be operated without the need to actuate any switches. The present invention also eliminates the need for a driver to read numbers from a list or even remember numbers while driving. The voice commands and speed dial lists permit quick and easy hands-free, non-visually distractive dialing so the drivers can at all times keep their eyes on the road.

Voice commands can be used to designate stored destinations to be used by the navigation system to establish routes. Again, this is done “hands free” and without visual distractions. The driver says “command” to activate the system. The driver can then say “list destinations” and the controller will list those stored in memory over the speaker. When the driver hears the desired destination, the driver says “travel there” to cause the system to plot a course from the vehicle's current location to that destination. A confirmation can then be played over the speaker 26 and the driver is directed to that location via the speaker 26 and the LEDs 29b-f. Of course, if the driver already knows the desired destination, the driver can load that destination by saying “command” followed by “travel to” and the name of the location.

The driver can also retrieve destination information from the telecommunications center 1 or one or more partners 5a-n or 6a-n. For example, if the driver wants to travel to a local restaurant that is also a local partner, the driver says “command”, “dine”, “local partners” and the list of local partners that are restaurants is read over the speaker 26. When the name of the desired restaurant is read, the driver says “travel there” rather than “dial now”. The system controller 12 then retrieves the location of the restaurant (either from its own memory, the telecommunications center 1, or a partner 5a-n, 6a-n) and uses this location information in combination with the vehicle location information provided by the GPS signal processor to plot a course from the vehicle's current location to the location of the restaurant. The system controller 12 then provides driving instructions to the driver using the speaker and LEDs 29b-f.

This navigation application is not limited to partners 5a-n, 6a-n. Through appropriate commands, any location can be retrieved from either the telecommunications center 1 or a partner 5a-n, 6a-n capable of transmitting to the vehicle location information related to points of interest to the driver. The system controller 12 can process this location information, ask the driver to confirm it is a desired destination, plot a course from the vehicle's current location to that location, and issue instructions to the driver via the speaker 26 and LEDs 29b-f.

Those skilled in the art will recognize that the voice commands described above can be varied without deviating from the invention. The key is the use of intuitive, easy-to-use commands that will cause the system to retrieve the desired information and act on that information in the manner contemplated by the driver. Likewise, a system that combines the use of the multifunction switches 28a-n with voice commands is well within the scope of this invention.

Those skilled in the art will also recognize that the objectives of the present invention can be achieved through different arrangements and uses of the switches of the type described above. The above description is intended to be exemplary rather than limiting and is provided to show how a user interface made in accordance with the present invention can reduce distractions to a driver and at the same time provide the driver with a robust set of alerts, driving directions, information and communications.

What is claimed is:

1. An integrated vehicle navigation and communications apparatus comprising:
a. a signal amplifier and antenna;
b. a GPS signal processor
c. a telephone;
d. a user interface at least a part of which surrounds the rear view mirror of the vehicle such that at least a portion of said mirror is movable between a first position in which only a first portion of said user interface is exposed to the view of the driver and a second position by which a second portion of said user interface is exposed to the view of the driver.

2. The integrated vehicle navigation and communications apparatus of claim 1 wherein said user interface includes a plurality of multifunction switches, a plurality of LEDs, a speaker and a microphone.

3. The integrated vehicle navigation and communications apparatus of claim 1 wherein said user interface includes an LED that is illuminated when a signal used by an emergency vehicle to control a traffic light is sensed.

4. The integrated vehicle navigation and communications apparatus of claim 1 wherein said user interface includes a plurality of LEDs used to provide instructions to a driver on how to reach a desired destination without displaying a street map.

5. The integrated vehicle navigation and communications system of either claim 1 or claim 4 wherein said user interface includes a speaker used to provide instructions to a driver on how to reach a desired destination without displaying a street map.

6. The integrated vehicle navigation and communications apparatus of claim 1 wherein said user interface includes a plurality of multifunction switches and a speaker.

7. The integrated vehicle navigation and communications apparatus of claim 6 further comprising a plurality of lists of names of parties and their telephone numbers, each such list being associated with a multifunction switch that can be actuated to cause the associated list of names to be played through the speaker and can be further actuated to move backward and forward through the list.

8. The integrated vehicle navigation and communications apparatus of claim 7 wherein a telephone connection can be established with a party by actuating a switch of the user interface as the party's name is being played through the speaker.

9. The apparatus of claim 7 wherein at least some of said lists are stored in the navigation and communications apparatus.

10. The apparatus of claim 7 wherein at least some of said lists are stored remotely and accessible using a telephone connection.

11. The integrated vehicle navigation and communications apparatus of claim 7 wherein there are at least two of said lists associated with at least one of said multifunction switches.

12. The apparatus of claim 11 wherein at least one of said at least two lists is stored in the navigation and communications apparatus and another is stored remotely.

13. The apparatus of claim 11 wherein a plurality of said lists are stored remotely and which list is played in response to actuation of one of said multifunction switches is a function of the location of the vehicle at the time of said actuation.

14. The integrated vehicle navigation and communications apparatus of claim 1 further comprising at least one switch, and at least one LED associated with said switch and a speaker wherein said LED is illuminated when the vehicle has received notice of an alert and wherein when said switch is activated while said LED is illuminated to cause information related to the alert to be played through said speaker.

15. The apparatus of claim 14 wherein said alert is a weather alert.

16. The apparatus of claim 14 wherein said alert is an emergency alert.

17. The apparatus of claim 1 wherein said user interface includes a switch for making a telephone connection to a remote telecommunications center and, upon making that connection, transmits a signal representative of the vehicle's location.

18. The apparatus of claim 1 wherein said apparatus transmits signals to a telecommunications center representative of the geographical location of the vehicle.

19. The apparatus of either claim 17 or claim 18 wherein said telecommunications center transmits information to the vehicle, based upon the vehicle's location, which are processed by the system controller to deliver messages to the driver via the user interface.

20. The apparatus of claim 1 wherein said integrated vehicle navigation and communications apparatus is coupled to an onboard diagnostic computer.

21. The apparatus of claim 20 wherein said integrated vehicle navigation and communications apparatus receives and processes signals received from said onboard diagnostic computer and causes information related thereto to be delivered to the driver via the user interface.

22. The apparatus of claim 20 wherein in the event of an airbag deployment, said onboard diagnostic computer sends a signal to said system controller which responds by causing a telephone connection to be established with a telecommunications center and then causes an advisory of the airbag deployment and the location of the vehicle to be transmitted to the telecommunications center.

23. The apparatus of claim 22 wherein said telecommunications center is the 911 emergency response center serving the area wherein the vehicle is then located.

24. The apparatus of claim 1 wherein said user interface further includes a plurality of switches, a plurality of LEDs, a display, a speaker and a microphone.

25. The apparatus of claim 1 wherein said telephone is coupled to said system controller.

26. The apparatus of claim 1 wherein said telephone is coupled to said system controller being a wireless connection.

27. The apparatus of claim 1 wherein said user interface includes a magnetic card reader.

28. The apparatus of claim 1 wherein said apparatus can be programmed with separate preferences for separate drivers.

29. The apparatus of claim 28 wherein further including means for sensing which driver is driving the vehicle and employing the preferences for said driver in response thereto.

30. The apparatus of claim 2 wherein the driver can engage in hands-free telephone communication.

31. The apparatus of claim 1 wherein said user interface includes a speaker used to provide instructions to a driver on how to reach a desired destination without displaying a street map.

32. The apparatus of claim 1 wherein said user interface includes a speaker and a plurality of LEDs used to provide instructions to a driver on how to reach a desired destination without displaying a street map.

33. An integrated vehicle navigation and communication apparatus comprising:
a. a system controller;
b. a signal amplifier and antenna;
c. a GPS signal processor;
d. a telephone; and
e. a user interface at least a part of which surrounds the rear view mirror of the vehicle such that at least a portion of said mirror is movable between a first position in which only a first portion of said user interface is exposed to the view of the driver and a second position by which a second portion of said user interface is exposed to the view of the driver, said user interface including a plurality of LEDs positioned about the mirror and associated labels, a microphone and a speaker.

34. The apparatus of claim 33 wherein some of said LEDs are used to provide instructions to a driver on how to reach a desired destination without displaying a street map.

35. The apparatus of claim 33 wherein said speaker is used to provide instructions to a driver on how to reach a desired destination without displaying a street map.

36. The apparatus of claim 33 wherein some of said LEDs and said speaker are used to provide instructions to a driver on how to reach a desired destination without displaying a street map.

37. The apparatus of claim 33 wherein said microphone is used by the driver to deliver voice commands which are processed by said system controller.

38. The apparatus of claim 37 wherein said voice commands can be used to designate a desired destination and said system controller uses said desired destination and information related to the location of the vehicle provided by the GPS signal processor to determine a route from the vehicle's location to the desired location.

39. The apparatus of claim 38 wherein driving instructions related to said route are delivered to the driver without displaying a road map.

40. The apparatus of claim 39 wherein said driving instructions are delivered using some of said LEDs.

41. The apparatus of claim 39 wherein said driving instructions are delivered using said speaker.

42. The apparatus of claim 39 wherein said driving instructions are delivered using said speaker and some of said LEDs.

43. The apparatus of claim 38 wherein said desired destination is selected from at least one list of destinations stored in the system controller.

44. The apparatus of claim 38 wherein said desired destination is selected from at least one list of destinations stored external to the vehicle on an apparatus capable of being accessed by the system controller via a telephone link.

45. The apparatus of claim 37 further including a plurality of lists of speed dial connections.

46. The apparatus of claim 45 wherein at least one of said plurality of lists of speed dial connections is stored in the system controller and at least one other of said plurality of lists is stored in an apparatus external to said vehicle which can be accessed by the system controller using a telephone link.

47. The apparatus of claim 45 wherein said microphone is used by the driver to issue voice commands related to the selection of speed dial connections from said plurality of lists of speed dial connections and to the placing of a telephone call to the selected speed dial connection.

48. The apparatus of claim 47 wherein said speaker is used to play information related to speed dial connections in said plurality of lists.

49. The apparatus of claim 33 further including a menu including the identity of a plurality of selectable destinations and location information to each selectable destination accessible by the system controller and used by the system controller to plot a course from the vehicle's then present location to a destination selected from said plurality of selectable destinations.

50. The apparatus of claim 49 wherein said menu is stored in the memory of the system controller.

51. The apparatus of claim 49 wherein said menu is stored at a location external to the vehicle in a manner that is accessible by the system controller via a telephone link.
